(19) United States
(12) Patent Application Publication
(10) Pub. No.: US 2014/0331960 A1
(43) Pub. Date: Nov. 13, 2014

(54) FLAME JET IGNITION ENGINE

(71) Applicant: Hyundai Motor Company, Seoul (KR)

(72) Inventors: Won Jun LEE, Incheon (KR); Jin Kook KONG, Suwon-si (KR); Byong Young CHOI, Bucheon-si (KR); Ki Wook SHIN, Ansan-si (KR); Young Hong KWAK, Suwon-si (KR); Soo Hyung WOO, Yongin-si (KR)

(73) Assignee: Hyundai Motor Company, Seoul (KR)

(21) Appl. No.: 14/014,109

(22) Filed: Aug. 29, 2013

(30) Foreign Application Priority Data
May 9, 2013 (KR) 10-2013-0052317

(51) Int. Cl. F02B 19/10

(52) U.S. Cl. CPC F02B 19/108
USPC 123/275

(57) ABSTRACT

A flame jet ignition engine enables air to be effectively fed to an auxiliary combustion chamber, thereby ensuring facilitating the formation of a fuel mixture of fuel and air and therefore leading to the smooth, stable ignition of the fuel mixture in the auxiliary combustion chamber.

### CROSS REFERENCE TO RELATED APPLICATION

The present application claims priority of Korean Patent Application Number 10-2013-0052317 filed May 9, 2013, the entire contents of which application is incorporated herein for all purposes by this reference.

### BACKGROUND OF INVENTION

1. Field of Invention

The present invention relates, in general, to a flame jet ignition engine and, more particularly, to a flame jet ignition engine in which a jet of the flame of a fuel mixture in an auxiliary combustion chamber is fed to a main combustion chamber so as to ignite a fuel mixture in the main combustion chamber.

2. Description of Related Art

Generally, a flame jet ignition engine is configured such that apart from a main combustion chamber, an auxiliary combustion chamber is provided, and a gas flame generated by ignition of a fuel mixture in the auxiliary combustion chamber is fed to the main combustion chamber so as to ignite a fuel mixture in the main combustion chamber to generate power.

That is to say, as shown in FIG. 1, a flame jet ignition engine is configured such that in order to ignite a fuel mixture being fed to a main combustion chamber 500, a fuel mixture in an auxiliary combustion 502 is first ignited to form a gas flame, followed by jetting the gas flame towards the main combustion chamber 500 via a jet nozzle 516 so as to ignite the fuel mixture in the main combustion chamber.

As shown in the figure, the auxiliary combustion chamber 502 has a compression chamber comprised of an auxiliary cylinder 504 on the upper side thereof, and the compression chamber has an injector 506 and an air inlet port 508 so as to accommodate fuel and air, which are fed from the injector and the air inlet port, respectively, and finally constitute a fuel mixture to be combusted in the auxiliary chamber 502. The fuel mixture in the compression chamber is fed to the auxiliary combustion chamber 502 via a check valve 512 while being compressed by a reciprocating auxiliary piston 510. The auxiliary combustion chamber 502 has an ignition plug 514 to ignite the fuel mixture being fed thereto.

Thus, in the flame jet ignition engine, the auxiliary cylinder 504 needs to be fed with air from the air inlet port 508 in order to form a combustible fuel mixture, together with fuel.

The information disclosed in this Background section is only for enhancement of understanding of the general background of the invention and should not be taken as an acknowledgement or any form of suggestion that this information forms the prior art already known to a person skilled in the art.

### BRIEF SUMMARY

Accordingly, the present invention has been made keeping in mind the above problems occurring in the related art, and the present invention is intended to propose a flame jet ignition engine which enables air to be effectively fed to an auxiliary combustion chamber, thereby ensuring facilitating the formation of a fuel mixture of fuel and air and therefore leading to the smooth, stable ignition of the fuel mixture in the auxiliary combustion chamber.

Various aspects of the present invention provide for a flame jet ignition engine including: an auxiliary cylinder configured to compress a fuel mixture to be fed to an auxiliary combustion chamber; an injector configured to spray fuel into the auxiliary cylinder; and an air-communication passage configured to communicate the auxiliary cylinder with the atmosphere.

According to another aspect of the present invention, a flame jet ignition engine includes: an auxiliary cylinder configured to compress a fuel mixture to be fed to an auxiliary combustion chamber; an injector configured to spray fuel into the auxiliary cylinder; a main combustion chamber configured to combust a fuel mixture being fed thereto with a flame jet fed from the auxiliary combustion chamber so as to generate power, and to which an intake port and an exhaust port are connected; and a port-connection passage configured to communicate the auxiliary cylinder with the intake port.

According to the present invention, the flame jet ignition engine enables air to be effectively fed to the auxiliary combustion chamber, thereby ensuring facilitating the formation of a fuel mixture of fuel and air and therefore leading to the smooth, stable ignition of the fuel mixture in the auxiliary combustion chamber.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a view showing a configuration of a flame jet ignition engine according to the related art;

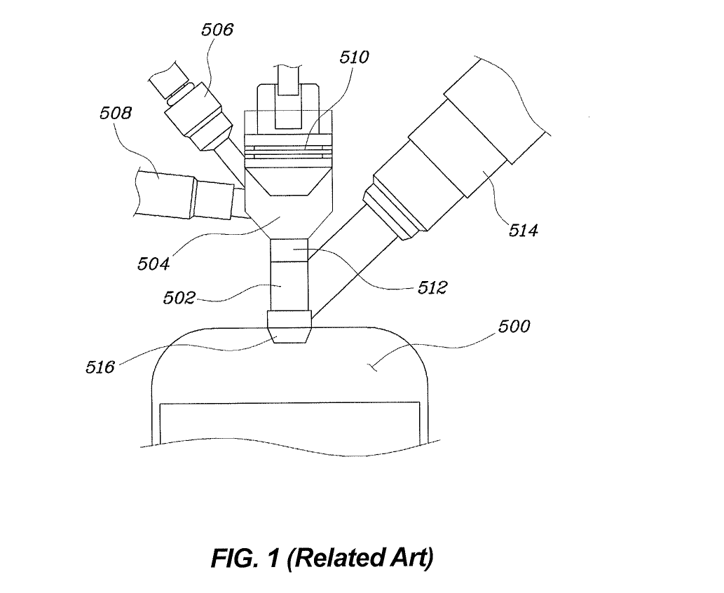

FIG. 2 is a view showing a configuration of an exemplary flame jet ignition engine according to the present invention; and

FIG. 3 is a view showing a configuration of an exemplary flame jet ignition engine according to the present invention.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

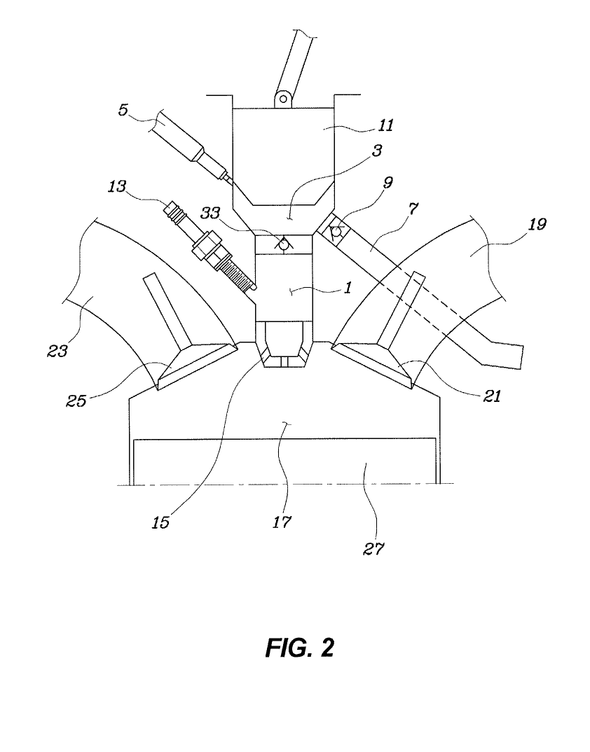

Referring to FIG. 2, a flame jet ignition engine according to various embodiments of the present invention includes an auxiliary cylinder 3 which compresses a fuel mixture to be fed to an auxiliary combustion chamber 1, an injector 5 which sprays fuel into the auxiliary cylinder 3, and an air-communication passage 7 which communicates the auxiliary cylinder 3 with the atmosphere.

That is, the auxiliary cylinder 3 is communicated directly to the atmosphere on the exterior of an engine, so that the auxiliary cylinder 3 can be fed with air via the air-communication passage 7.

A first check valve 9 may be further installed to the air-communication passage 7 so as to permit one-way air flow from the atmosphere towards the auxiliary cylinder 3.

An auxiliary piston 11 is further installed to the auxiliary cylinder 3 so as to compress the fuel mixture in the auxiliary cylinder 3 through linear reciprocation thereof, and feed the compressed mixture to the auxiliary combustion chamber 1. An ignition plug 13 is provided in the auxiliary combustion chamber 1 so as to ignite the fuel mixture fed thereto. The auxiliary combustion chamber 1 communicates with a main combustion chamber 17 via a jet nozzle 15 in order to transmit a flame jet to the main combustion chamber. The main combustion chamber 17 has an intake port 19 and an intake valve 21 for sucking fuel and air, an exhaust port 23 and an exhaust valve 25 for discharging combusted exhaust gas, and a main piston 27 which makes a linear reciprocating motion with power generated by the combustion of the fuel mixture of fuel and air.

Thus, according to various embodiments, it is possible to independently control inflow of air introduced into the auxiliary cylinder 3 irrespective of a load of an engine, and identical amounts of air and fuel are applied throughout the entire operation period of an engine, so the control of the fuel mixture and the mechanical configuration implementing the control are simplified, thereby saving on the cost of an engine.

Further, optimal air volume and air-fuel ratio for the ignition of a fuel mixture is stably obtained in the auxiliary combustion chamber 1, having advantageous effects of forming a constant, stable flame throughout the entire operation period of an engine and therefore ensuring combustion stability for the engine.

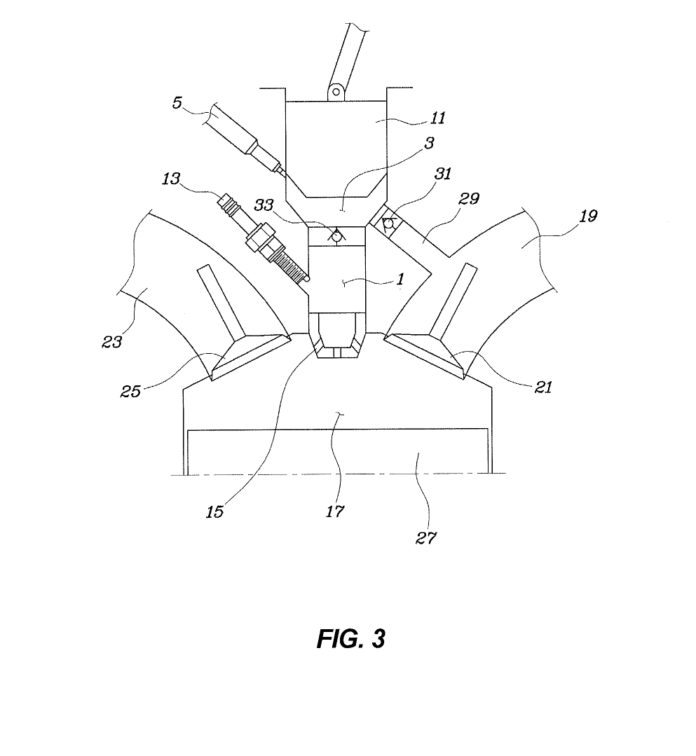

Referring to FIG. 3, a flame jet ignition engine according to various embodiments of the present invention includes: an auxiliary cylinder 3 which compresses a fuel mixture to be fed to an auxiliary combustion chamber 1; an injector 5 which sprays fuel into the auxiliary cylinder 3; a main combustion chamber 17 which combusts a fuel mixture being fed thereto with a flame jet fed from the auxiliary combustion chamber 1 so as to generate power, and to which an intake port 19 and an exhaust port 23 are connected; and a port-connection passage 29 which communicates the auxiliary cylinder 3 with the intake port 19.

That is to say, air is introduced into the auxiliary cylinder 3 via the intake port 19 that is a passage of air to be fed to the main combustion chamber 17, so that air being fed to the auxiliary cylinder 3 is influenced by an air flow through the intake port 19, thereby resultantly obtaining the control of air volume depending on load of an engine.

A second check valve 31 may be further installed to the port-connection passage 29 so as to permit one-way air flow from the intake port 19 towards the auxiliary cylinder 3.

An auxiliary piston 11 is installed to the auxiliary cylinder 3 so as to compress the fuel mixture in the auxiliary cylinder 3 through linear reciprocation thereof, and feed the compressed mixture to the auxiliary combustion chamber 1. An ignition plug 13 is provided in the auxiliary combustion chamber 1 so as to ignite the fuel mixture fed from the auxiliary cylinder 3. The auxiliary combustion chamber 1 communicates with a main combustion chamber 17 via a jet nozzle 15 in order to transmit a flame jet to the main combustion chamber 17. The main combustion chamber 17 has an intake valve 21 and an exhaust valve 25 to open and shut the intake port 19 and the exhaust port 23, respectively, and a main piston 27 which makes a linear reciprocating motion with power generated by the combustion of the fuel mixture of fuel and air.

Thus, according to various embodiments, the port-connection passage 29 communicates with the intake port 19 so that an amount of air fed to the auxiliary cylinder 3 varies depending on the load of an engine. Thereby, an amount of fuel is controlled in conformity with the automatically-regulated air volume by the load, resulting in a reduction in fuel consumption in the auxiliary cylinder 3 and the auxiliary combustion chamber 1, contributing to an improvement of fuel efficiency of an engine.

Further, as described above, various embodiments are relatively advantageous in obtaining optimal combustion characteristics suitable for a load of an engine by accomplishing the formation of optimal fuel mixture and resultant flames corresponding to the load of an engine.

Further, according to various embodiments, a third check valve 33 is installed between the auxiliary cylinder 3 and the auxiliary combustion chamber 1 so as to permit one-way flow of the fuel mixture from the auxiliary cylinder 3 towards the auxiliary combustion chamber 1.

Thus, a flame generated from the auxiliary combustion chamber 1 is only jetted to the main combustion chamber 17 via the jet nozzle 15, and is not reversely directed towards the auxiliary cylinder 3 by the third check valve 33.

For convenience in explanation and accurate definition in the appended claims, the terms upper and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A flame jet ignition engine comprising:
an auxiliary cylinder configured to compress a fuel mixture to be fed to an auxiliary combustion chamber;
an injector configured to spray fuel into the auxiliary cylinder; and
an air-communication passage configured to communicate the auxiliary cylinder with the atmosphere.

2. The flame jet ignition engine according to claim 1, further comprising a first check valve installed in the air-communication passage to permit one-way air flow from the atmosphere into the auxiliary cylinder.

3. The flame jet ignition engine according to claim 2, further comprising:
an auxiliary piston is in the auxiliary cylinder to compress the fuel mixture in the auxiliary cylinder through linear reciprocation thereof, and feed the compressed mixture to the auxiliary combustion chamber; and
a main piston having a linear reciprocating motion with power generated by the combustion of the fuel mixture of fuel and air;
wherein an ignition plug is provided in the auxiliary combustion chamber to ignite the fuel mixture fed thereto, wherein the auxiliary combustion chamber communicates with a main combustion chamber via a jet nozzle in order to transmit a flame jet to the main combustion chamber; and
wherein the main combustion chamber has an intake port and an intake valve for sucking fuel and air, an exhaust port and an exhaust valve for discharging combusted exhaust gas.

4. A flame jet ignition engine comprising:
an auxiliary cylinder configured to compress a fuel mixture to be fed to an auxiliary combustion chamber;
an injector configured to spray fuel into the auxiliary cylinder;
a main combustion chamber configured to combust a fuel mixture being fed thereto with a flame jet fed from the auxiliary combustion chamber to generate power, and to which an intake port and an exhaust port are connected; and
a port-connection passage configured to communicate the auxiliary cylinder with the intake port.

5. The flame jet ignition engine according to claim 4, further comprising a second check valve installed in the port-connection passage to permit one-way air flow from the intake port towards the auxiliary cylinder.

6. The flame jet ignition engine according to claim 5, further comprising:
an auxiliary piston installed in the auxiliary cylinder to compress the fuel mixture of the auxiliary cylinder through linear reciprocation thereof, and feed the compressed mixture to the auxiliary combustion chamber;
an ignition plug provided in the auxiliary combustion chamber to ignite the fuel mixture fed from the auxiliary cylinder; and
a main piston which makes a linear reciprocating motion with power generated by the combustion of the fuel mixture of fuel and air
wherein the auxiliary combustion chamber communicates with a main combustion chamber via a jet nozzle in order to transmit a flame jet to the main combustion chamber; and
wherein the main combustion chamber has an intake valve and an exhaust valve to open and shut the intake port and the exhaust port, respectively.

7. The flame jet ignition engine according to claim 3, wherein a third check valve is installed between the auxiliary cylinder and the auxiliary combustion chamber so as to permit one-way flow of the fuel mixture from the auxiliary cylinder towards the auxiliary combustion chamber.
